(19) United States
(12) Patent Application Publication
(10) Pub. No.: US 2026/0088278 A1
(43) Pub. Date: Mar. 26, 2026

(54) MAKING METAL BATTERY GRIDS FOR LEAD-ACID BATTERY MANUFACTURE WITH LASER CLEANING AND ASSEMBLY THEREFOR

(71) Applicant: Wirtz Manufacturing Company, Inc., Port Huron, MI (US)

(72) Inventors: Michael R. Romeo, St. Clair, MI (US); Jason P. Miller, St. Clair, MI (US)

(21) Appl. No.: 19/341,094

(22) Filed: Sep. 26, 2025

Related U.S. Application Data
(60) Provisional application No. 63/699,377, filed on Sep. 26, 2024.

(51) Int. Cl. H01M 4/22; B23K 26/34

(52) U.S. Cl. CPC H01M 4/22; B23K 26/34

(57) ABSTRACT

A method of making metal battery grids for lead-acid battery manufacture, as well as a metal battery grid manufacture assembly for lead-acid batteries, are set forth. A cleaning operation is performed to a continuous strip of metal battery grids that is continuously produced. The cleaning operation involves emittance of one or more laser beams via one or more laser assemblies to one or more exterior surfaces of the continuous strip of metal battery grids. Residual lubricants, oils, corrosion, and/or other additives or unwanted contaminants residing at the exterior surface(s) can be partially or wholly removed via the emittance of the laser beam(s). Enhanced surface adherence of a subsequently-applied battery paste material at the exterior surface(s) can result.

### CROSS-REFERENCE TO RELATED APPLICATION

This application claims the benefit of U.S. Provisional Patent Application No. 63/699,377, with a filing date of September 26, 2024, the contents of which are hereby incorporated by reference in their entirety.

### TECHNICAL FIELD

This disclosure relates generally to lead-acid battery component manufacturing equipment and processes and, more particularly to, equipment and processes employed to manufacture battery plates and battery grids for lead-acid batteries.

### BACKGROUND

Lead-acid batteries are a common source of electrical energy and are often used as automotive batteries, marine batteries, consumer equipment batteries, small engine batteries, industrial batteries, as well as in other applications. Among their components, lead-acid batteries typically include numerous positive and negative plates that are assembled in a case and are made of metal grids, typically lead-based, with an electrochemically-active battery paste material applied on the grids. The grids serve as the current conductor or current collector of the established electrode, and the paste material serves as the active electrochemical material of the electrode.

Making lead-based grids remains an important part in the manufacture of commercially suitable lead-acid batteries. It often involves considerable metallurgic microstructure control to impart satisfactory mechanical strength, corrosion resistance, creep resistance, paste adhesion, as well as other sought-after properties. For commercial and mass production of battery plates, the grids can be produced via a continuous production procedure and can then be subjected to a paste application procedure, among other procedures that can be carried out. An example of a continuous casting machine for continuous production is described in U.S. Patent No. 4,415,016, assigned to Wirtz Manufacturing Company, Inc., the present applicant. And an example of a pasting machine is described in U.S. Patent No. 4,606,383, assigned to the present applicant.

### SUMMARY

In an embodiment, a method of making metal battery grids used in lead-acid battery manufacture involves multiple steps. One step may involve continuously producing a continuous strip of metal battery grids. Another step may involve emitting a laser beam to one or more exterior surfaces of the continuous strip of metal battery grids. The emittance of the laser beam may occur downstream of continuously producing the continuous strip of metal battery grids.

In an embodiment, a metal battery grid manufacture assembly for lead-acid batteries is set forth. The metal battery grid manufacture assembly may include a continuous production machine and one or more laser assemblies. The continuous production machine produces a continuous strip of metal battery grids. The laser assembly(ies) exhibits a location that is situated downstream of the continuous production machine. The laser assembly(ies) emits a laser beam to one or more exterior surfaces of the continuous strip of metal battery grids for cleaning the exterior surface(s) of the continuous strip of metal battery grids.

In an embodiment, a method of making metal battery grids used in lead-acid battery manufacture involves multiple steps. One step may involve continuously producing a continuous strip of metal battery grids. Another step may involve emitting a first laser beam to one or more exterior surfaces of the continuous strip of metal battery grids. The emittance of the first laser beam may occur downstream of continuously producing the continuous strip of metal battery grids. And the emittance of the first laser beam may occur upstream of a spooling operation of the continuous strip of metal battery grids. Yet another step may involve emitting a second laser beam to the exterior surface(s) of the continuous strip of metal battery grids. The emittance of the second laser beam may occur downstream of the emittance of the first laser beam. And the emittance of the second laser beam may occur upstream of application of an electrochemically-active battery paste material to the continuous strip of metal battery grids.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a schematic block diagram of an embodiment of a battery plate manufacture assembly production line with one or more laser assemblies;

FIG. 2 is a side view of an example of a continuous production machine in the form of a battery grid continuous casting machine;

FIG. 3 is a front view of the battery grid continuous casting machine;

FIG. 4 shows an example of a continuous strip or web of metal battery grids;

FIG. 5 is a perspective view of an example of an electrochemically-active battery paste application machine;

FIG. 6 is a perspective view of an embodiment of a continuous casting production line assembly; and

FIG. 7 is a perspective view of an embodiment of a battery paste application production line assembly.

### DETAILED DESCRIPTION

With reference to the figures, an embodiment of a battery grid and plate manufacture assembly production line 10 equipped with one or more laser assemblies 12, and method thereof, is shown and described herein. The laser assembly(ies) 12 serves to furnish a non-contact cleaning operation to a continuous strip of metal battery grids 14 produced continuously via the battery grid and plate manufacture assembly production line 10. Residual lubricants, oils, corrosion, and/or other additives or unwanted contaminants residing at surfaces of the continuous strip of metal battery grids 14 can be partially or wholly removed via activation and application of the laser assembly(ies) 12. In the past, undesired surface additives such as lubricants and oils were subjected to an ultrasonic cleaning operation that would rinse the gids, wash the grids with detergent, and carry out ultrasonic actions to pull the additives from grid surfaces. The grids would then need to be fully dried or risk unwanted oxidation on grid wires, jeopardizing effectiveness. High pressure air and often heated air would be used for drying. While effective, this past ultrasonic and drying approach typically could require significant floor space, could be costly, and could contribute to environmental and hazardous waste concerns.

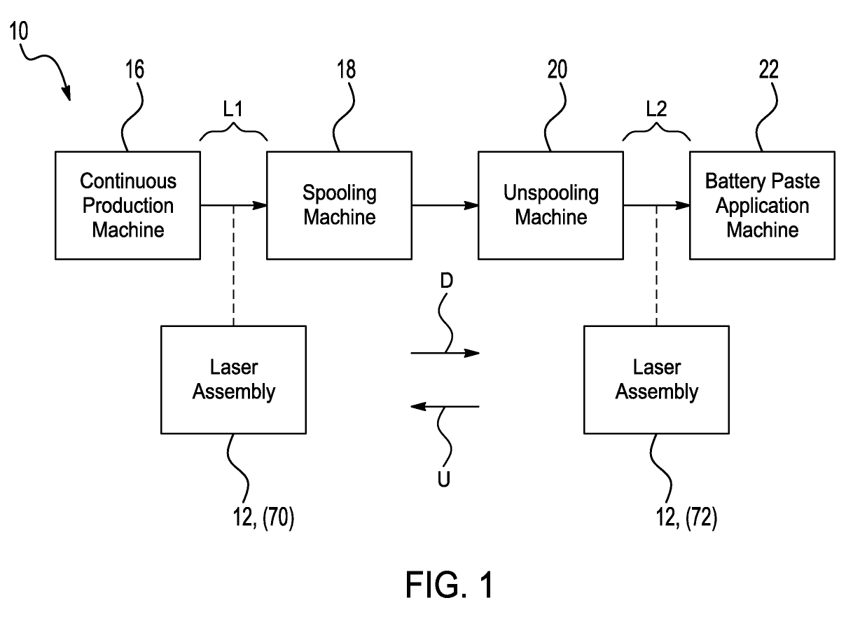

The cleaning operation furnished via the laser assembly(ies) 12, on the other hand, can be readily incorporated into a battery grid and plate manufacture assembly production line, is more easily integrated in-line into battery grid and plate manufacture assembly production lines, calls for minimal floor space, and minimizes or altogether eliminates contributions to environmental and hazardous waste concerns, among other potential advancements; still, a particular embodiment of the battery grid and plate manufacture assembly production line 10 and method may exhibit only one, or a combination of, the advancements set forth herein, none of the advancements, or other advancements unmentioned herein. Incorporation of the laser assembly(ies) 12 rids the need for the previous ultrasonic and drying operations in the battery grid and plate manufacture assembly production line 10 and method. Overall, a more effective and efficient battery grid and plate manufacture assembly production line 10 and method are provided, enhancing facilitation of commercial and mass production operations in lead-acid battery component manufacture. Further, the battery grid and plate manufacture assembly production line 10 and method can be employed in a larger manufacturing setup and process that produces lead-acid batteries for automotive applications, marine applications, consumer equipment applications, small engine applications, and industrial applications, among many other possibilities. Furthermore, as used herein, the terms upstream and downstream refer to directions with respect to the general and intended aggregate movement and progression of grid processing from casting to paste application amid their manufacture; in FIG. 1, upstream is generally represented by arrowed line U and downstream is generally represented by arrowed line D.

The battery grid and plate manufacture assembly production line 10 and method can include various processes, steps, and machines according to various embodiments. According to the embodiment of FIG. 1, the battery grid and plate manufacture assembly production line 10 generally includes a continuous production machine 16, a spooling machine 18, an unspooling machine 20, and an electrochemically-active battery paste application machine 22, as main components and assemblies; still, the battery grid and plate manufacture assembly production line 10 could include more, less, and/or different steps in other embodiments. Further, one or more of the laser assembly(ies) 12 are equipped and situated at various locations in the battery grid and plate manufacture assembly production line 10 in FIG. 1 for cleaning and removal purposes, as described below.

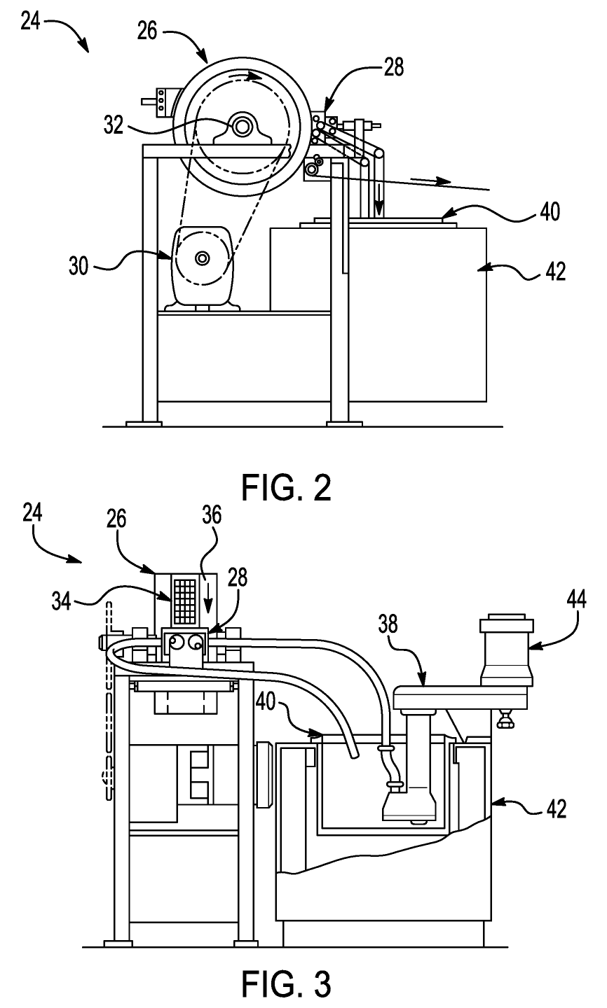

The continuous production machine 16 serves to continuously produce the continuous strip of metal battery grids 14. The continuous production machine 16 can take various forms in various embodiments. For example, the continuous production machine 16 can be a continuous casting machine that involves continuously casting for production of the continuous strip of metal battery grids 14, can be a continuous punching machine that involves continuously punching for production of the continuous strip of metal battery grids 14, can involve perforation machines and operations, and/or can involve compression machines and operations such as a series of compression rollers, among other kinds and types of continuous production machines. An example of a continuous casting machine is disclosed in U.S. Patent No. 11,253,914, assigned to the present applicant, and the contents of which are hereby incorporated herein in their entirety by reference. In the present patent, an example of a battery grid continuous casting machine 24 is shown in FIGS. 2 and 3. The casting machine 24 includes, as its primary components, a casting drum 26 and a shoe 28. The casting drum 26 is driven to rotate by an electric motor 30 (e.g., variable speed electric motor) about a bearing assembly 32. A mold cavity 34 resides in a cylindrical outer surface 36 of the casting drum 26. The mold cavity 34 exhibits a predetermined battery grid pattern. Lead-based material in a molten state is supplied via the shoe 28 and to a confronting section of the mold cavity 34 of the casting drum 26 amid rotation. The molten lead is received in the mold cavity 34 and, upon its solidification, produces the now-cast continuous strip of metal battery grids 14. A pump 38 supplies the molten lead at a super atmospheric pressure from a melting pot 40 of a furnace 42 and to the shoe 28. An electric motor 44 (e.g., variable speed electric motor) can drive the pump 38. Alteration of the super atmospheric pressure and/or flow rate of the molten lead is effected via the electric motor 44 and pump 38. Excess molten lead may be returned from the shoe 28 to the melting pot 40. Still, other kinds and types of casting equipment and machines could be employed in other embodiments.

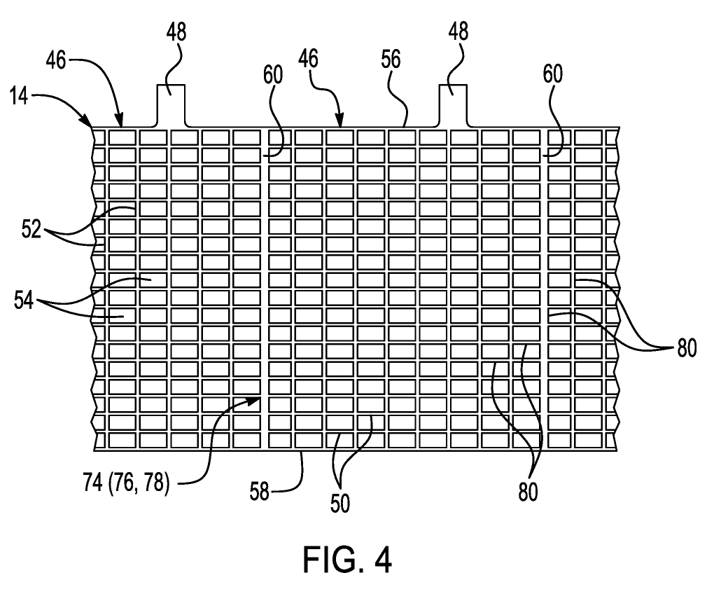

With reference now to FIG. 4, an example of an as-cast continuous strip of metal battery grids 14 or elongated web is depicted; examples of grids made from other continuous production operations and machines can resemble the example in the figure. The continuous strip of metal battery grids 14 includes multiple individual metal battery grids 46 that are connected together at this stage of processing, but are ultimately severed and separated prior to installation in a lead-acid battery. The grids 46 are typically flat, planar, and thin, and designed and constructed per parameters of the lead-acid battery in which they are installed. The grids 46 can be utilized for a positive plate (i.e., cathode) and a negative plate (i.e., anode) of an assembled lead-acid battery. In the example of FIG. 4, the continuous strip of metal battery grids 14 includes connector lugs 48 provided for each grid 46. The continuous strip of metal battery grids 14 and each individual grid 46, per this example, has a multitude of horizontally-extending grid wires 50 and a multitude of vertically-extending grid wires 52 in a crisscrossing arrangement. The grid wires 50, 52 intersect one another at nodes, and open and empty spaces 54 reside among the grid wires 50, 52. A top frame wire 56 and a bottom frame wire 58 bound the associated extents of the continuous strip of metal battery grids 14 and each individual grid 46, and side frame wires 60 bound sides of each grid 46. Still, the continuous strip of metal battery grids could have other designs, constructions, and arrangements in other examples; for instance, two sets of continuous strips connected in parallel could be cast concurrently, and/or the grid wires could have other patterns such as an angular zig-zag pattern. Such alternatives will be appreciated by skilled artisans.

The spooling machine 18 — also called a reeler or a coiler — serves to perform a spooling operation for the continuous strip of metal battery grids 14 in which the grids are wound and coiled into a spool for subsequent transport and/or storage purposes after continuous production and before battery paste application. The spooling machine 18 can take various forms in various embodiments. With reference again to FIG. 1, in this embodiment the spooling machine 18 is situated and equipped downstream of the continuous production machine 16 and upstream of the unspooling machine 20 and battery paste application machine 22. Furthermore, after spooling, the unspooling machine 20 — also called a dereeler — serves to perform an unspooling operation for the continuous strip of metal battery grids 14 in which the grids are unwound and uncoiled for subsequent processing and battery paste application. The unspooling machine 20 can take various forms in various embodiments. In the embodiment of FIG. 1, the unspooling machine 20 is situated and equipped downstream of the continuous production machine 16 and downstream of the spooling machine 18, and is situated and equipped upstream of the battery paste application machine 22.

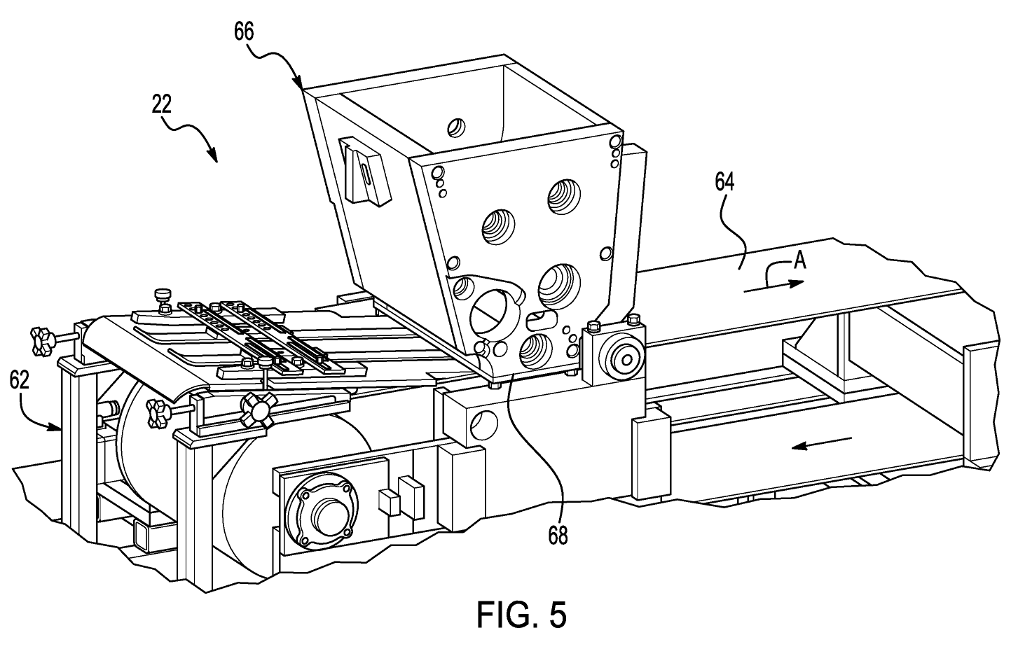

The battery paste application machine 22 serves to apply electrochemically-active battery paste material to the continuous strip of metal battery grids 14. The battery paste application machine 22 can take various forms in various embodiments. One example is disclosed in U.S. Patent No. 9,437,867, assigned to the present applicant, and the contents of which are hereby incorporated herein in their entirety by reference. In the present patent, an example of the battery paste application machine 22 is shown in FIG. 5. In this example, the battery paste application machine 22 is a steel belt paster machine. The battery paste application machine 22 includes, as its primary components, a frame 62, a belt 64, and a hopper 66. The belt 64 carries the continuous strip of metal battery grids 14 through the battery paste application machine 22 underneath the hopper 66, and is typically driven by an electric motor and one or more rollers. The belt 64 is an endless belt, and motions of its upper and lower runs are denoted in FIG. 5 by arrow A. The hopper 66 holds battery paste material and dispenses it onto the continuous strip of metal battery grids 14 as the grids pass beneath the hopper 66 amid use of the battery paste application machine 22. Further, to keep the electrochemically-active battery paste material in a mixed state for ready dispensation, multiple internal feed rollers and paddles can be mounted at an interior of the hopper 66 and submerged within the battery paste material. An orifice plate 68 is mounted to a bottom end of the hopper 66 and, with the exception of an orifice slot residing in the plate, generally closes the bottom end. Electrochemically-active battery paste material is fed through the orifice slot from the hopper’s interior and to the continuous strip of metal battery grids 14 passing beneath the hopper 66. In the embodiment of FIG. 1, the battery paste application machine 22 is situated and equipped downstream of the continuous production machine 16, downstream of the spooling machine 18, and downstream of the unspooling machine 20. Further, after battery paste application, the continuous strip of metal battery grids 14 can undergo a severing operation in which the strip is cut into multiple individual pasted battery grids for subsequent stacking and deployment in lead-acid batteries.

Downstream of the continuous production machine 16 in the battery grid and plate manufacture assembly production line 10, it has been observed that certain unwanted additives and contaminants can be transferred to, and/or can develop on, surfaces of the continuous strip of metal battery grids 14. For instance, lubricants, oils, coolants, and/or other substances are commonly employed during continuous production operations such as during use of the battery grid continuous casting machine 24 and can make their way to grid surfaces; and corrosion like oxide and scale can build on grid surfaces during transport and/or storage following the spooling operation. Such residual additives and contaminant formations on grid surfaces have shown to be detrimental to surface adherence of the subsequently-applied battery paste material, as well as to subsequent lead-acid battery capacity and performance. Moreover, residual lubricants, oils, coolants, and/or other substances have been observed within voids and invaginations in the grid metallic structure as a consequence of certain continuous production operations such as continuous casting operations. This too can be detrimental to surface adherence of battery paste material and to battery capacity and performance. In more extreme cases, when left unresolved, the residual additives and contaminant formations can cause lead-acid battery failure.

The laser assembly(ies) 12 serves to at least partially or fully clean and remove the residual additives and/or contaminant formations from exterior surfaces of the continuous strip of metal battery grids 14, as well as any residual additives that may have made their way within voids and invaginations in the continuous strip of metal battery grids 14. Enhanced surface adherence of the subsequently-applied battery paste material is furnished via the partial or full cleaning and removal. One or more laser beams are emitted from the laser assembly(ies) 12 and applied directly to the continuous strip of metal battery grids 14. In various embodiments, the laser assembly(ies) 12 can have various arrangements relative to other machines in the battery grid and plate manufacture assembly production line 10, can itself take various forms, and can come in various quantities, among other possibilities. In the embodiment of FIG. 1, the laser assembly(ies) 12 is situated and equipped downstream of the continuous production machine 16 and upstream of the battery paste application machine 22. More particularly, in this embodiment the laser assembly(ies) 12 is located and positioned to emit the laser beam(s) in-between the continuous production machine 16 (e.g., a continuous casting machine or continuous punching machine or other) and the spooling machine 18, and downstream of the continuous production machine 16 and upstream of the spooling machine 18. Further, the laser assembly(ies) 12 is located and positioned to emit the laser beam(s) in-between the unspooling machine 20 and the battery paste application machine 22, and downstream of the unspooling machine 20 and upstream of the battery paste application machine 22. Still, other locations and positions are possible, depending on the operations and machines of a particular battery grid and plate manufacture assembly production line.

The battery grid and plate manufacture assembly production line 10 can have a single laser assembly 12 in its design and construction, or can have multiple laser assemblies 12 in its design and construction. When single, the laser assembly 12 can be equipped in-between the continuous production machine 16 and spooling machine 18, or can be equipped in-between the unspooling machine 20 and battery paste application machine 22, per the embodiment of the figures; still, other locations are possible in this embodiment and other embodiments. When multiple, a first laser assembly 70 can be equipped at a first location L1 in-between the continuous production machine 16 and spooling machine 18, and a second laser assembly 72 can be equipped at a second location L2 in-between the unspooling machine 20 and battery paste application machine 22. The first and second laser assemblies 70, 72 can take the same forms and be of the same kind and type relative to each other, or can differ in form, kind, and/or type relative to each other. Lubricants, oils, coolants, and/or other substances resulting from continuous production are targeted for removal at the first location L1 after the continuous production operation and before the spooling operation of the continuous strip of metal battery grids 14 (i.e., targeted by the first laser assembly 70); and contaminant formations like corrosion, oxide, and scale are targeted for removal at the second location L2 after storage and after the unspooling operation but before the battery paste application operation to the continuous strip of metal battery grids 14 (i.e., targeted by the second laser assembly 72). Laser beam application intensities and/or other parameters can differ at the first location L1 and second location L2 and for the respective first and second laser assemblies 70, 72 based on the targeted removals, per an example. Enhanced surface adherence of the subsequently-applied battery paste material with the continuous strip of metal battery grids 14 is hence more readily enabled, and intended and increased battery capacity and performance is hence more readily ensured.

Furthermore, the laser beam(s) emitted by the laser assembly(ies) 12 can be applied while the continuous strip of metal battery grids 14 is in the midst of processing movement in the battery grid and plate manufacture assembly production line 10. In other words, movement of the continuous strip of metal battery grids 14 need not cease or otherwise pause for cleaning and removal of the residual additives and/or contaminant formations via the laser assembly(ies) 12. The continuous strip of metal battery grids 14 can continue and maintain its downstream movement and pace from the continuous production machine 16 and to the spooling machine 18 when the laser assembly(ies) 12 is deployed at the first location L1, and similarly the continuous strip of metal battery grids 14 can continue and maintain its downstream movement and pace from the unspooling machine 20 and to the battery paste application machine 22 when the laser assembly(ies) 12 is deployed at the second location L2. In this way, the laser assembly(ies) 12 and its laser beam application and emission can be readily incorporated and integrated into the battery grid and plate manufacture assembly production line 10, further enhancing facilitation of commercial and mass production operations in lead-acid battery component manufacture.

The laser beam(s) emitted by the laser assembly(ies) 12 is directed to one or more exterior surfaces 74 (FIG. 4) of the continuous strip of metal battery grids 14. The exterior surface(s) 74 can include an upper exterior surface 76 of the continuous strip of metal battery grids 14, a lower exterior surface 78 of the continuous strip of metal battery grids 14, or both the upper and lower exterior surfaces 76, 78 of the continuous strip of metal battery grids 14. Further, the exterior surface(s) 74 can include side exterior surfaces 80 of the continuous strip of metal battery grids 14. The side exterior surfaces 80 define and confront the open and empty spaces 54 at an interior thereof. The upper exterior surface 76, lower exterior surface 78, and side exterior surfaces 80 can be established by the structures of the continuous strip of metal battery grids 14. In the example of FIG. 4, the upper, lower, and side exterior surfaces 76, 78, 80 are established by the horizontally-extending grid wires 50, vertically-extending grid wires 52, top frame wire 56, bottom frame wire 58, and side frame wires 60. Still, the exterior surface(s) 74 can be established by other structures and surfaces for other designs, constructions, and arrangements of continuous strips of metal battery grids in other embodiments.

The laser assembly(ies) 12 can have various forms, kinds, and types in various embodiments. In an example embodiment, the laser assembly(ies) 12 can be a fiber laser assembly. The fiber laser assembly can emit one or more pulsed laser beams. The emitted laser beam(s) can be aimed and directed at the exterior surface(s) 74 of the continuous strip of metal battery grids 14, and can provide non-contact cleaning capabilities for removal of the residual additives and/or contaminant formations. The laser assembly(ies) 12 and fiber laser assembly can include a laser head in which the laser beam(s) is emitted from. The laser head can be mounted and fixtured in place in the battery grid and plate manufacture assembly production line 10. Its placement can be above, below, and/or at a side of the continuous strip of metal battery grids 14, depending on the implementation and installation. It has been determined that in order to more readily ensure the integrity of the structure of the continuous strip of metal battery grids 14 without appreciable or without any changes thereto, a level of power of the emitted laser beam(s) can range approximately from 50 watts (W) to 500 W; still, other levels of power are possible in other example embodiments. The laser assembly(ies) 12 can be supplied by Boss Laser, LLC of Florida, USA (www.bosslaser.com); still, other suppliers of laser technology and equipment are possible.

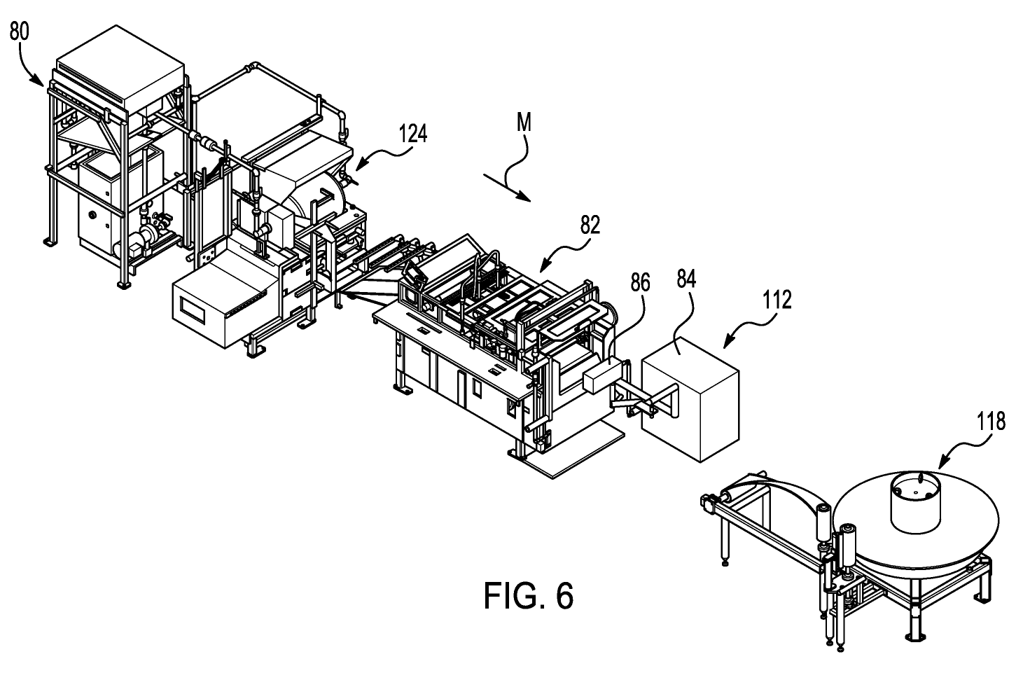

With reference now to FIG. 6, an embodiment of a continuous casting production line assembly 80 is presented. Here, corresponding components and elements are numbered similarly as in preceding figures but with numerals 1xx when referring to this embodiment. Moreover, many similarities exist between this embodiment and previous embodiments, some of which may not be repeated here in the description of this embodiment. At least certain appreciable differences between the embodiments are described. In the embodiment of FIG. 6, the continuous casting production line assembly 80 includes a battery grid continuous casting machine 124, a grid take-off (GTO) machine 82, a laser assembly 112, and a spooling machine 118. Processing movement and advancement in the continuous casting production line assembly 80 is generally represented by arrowed line M in FIG. 6. The grid take-off machine 82 serves to draw and pull a cast continuous strip of metal battery grids exiting the battery grid continuous casting machine 124 for downstream processing. The grid take-off machine 82 can take various forms in various embodiments. In FIG. 6, the grid take-off machine 82 is situated and equipped immediately downstream of the battery grid continuous casting machine 124 and immediately upstream of the laser assembly 112.

The laser assembly 112, on the other hand, is situated and equipped immediately downstream of the grid take-off machine 82 and immediately upstream of the spooling machine 118. The laser assembly 112 includes, as its primary components, a generator and control assembly 84 and a laser head 86. The laser head 86 is mounted in place directly above the continuous strip of metal battery grids as the grids exit the grid take-off machine 82 and are being transported to the spooling machine 118. Laser beams from the laser head 86 can hence be directed generally downward at the continuous strip of metal battery grids. Movement of the continuous strip of metal battery grids need not cease or otherwise pause for application of the associated laser beam(s). Lubricants, oils, coolants, and/or other substances resulting from battery grid continuous casting machine 124 are targeted for removal via the laser assembly 112 in this embodiment of the continuous casting production line assembly 80. A spooling operation of the cast continuous strip of metal battery grids takes place at the spooling machine 118.

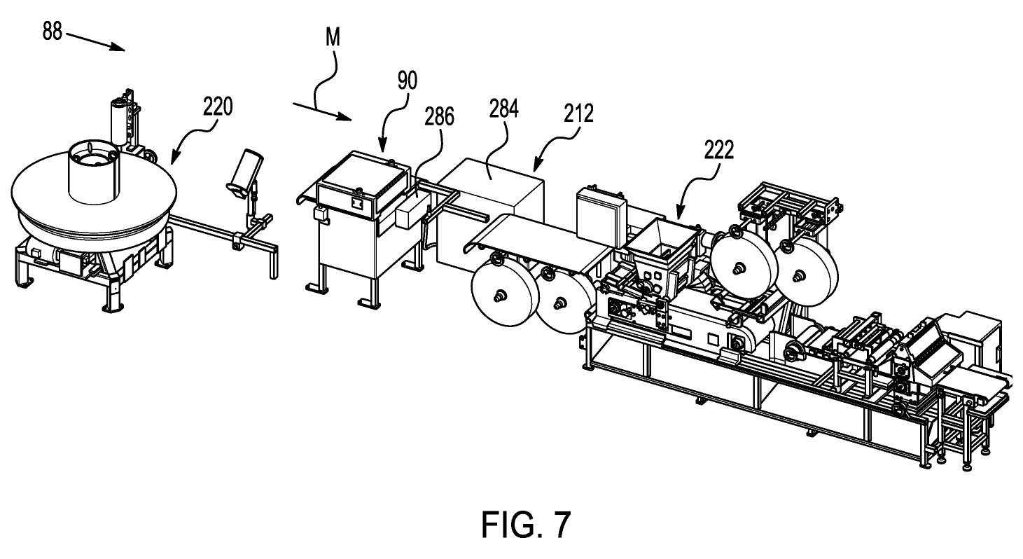

With reference now to FIG. 7, an embodiment of a battery paste application production line assembly 88 is presented. Here, corresponding components and elements are numbered similarly as in preceding figures but with numerals 2xx when referring to this embodiment. Moreover, many similarities exist between this embodiment and previous embodiments, some of which may not be repeated here in the description of this embodiment. At least certain appreciable differences between the embodiments are described. The battery paste application production line assembly 88 can be situated downstream of the continuous casting production line assembly 80 in a larger battery grid and plate manufacture assembly production line. In the embodiment of FIG. 7, the battery paste application production line assembly 88 includes an unspooling machine 220, a material take-off (MTO) machine 90, a laser assembly 212, and a battery paste application machine 222. Processing movement and advancement in the battery paste application production line assembly 88 is generally represented by arrowed line M in FIG. 7. In this embodiment, the unspooling machine 220 can receive the previously-spooled continuous strip of metal battery grids and unspool and unwind the spooled continuous strip of metal battery grids. The material take-off machine 90 serves to draw and pull the unspooled continuous strip of metal battery grids from the unspooling machine 220 for downstream processing. The material take-off machine 90 can take various forms in various embodiments. In FIG. 7, the material take-off machine 90 is situated and equipped immediately downstream of the unspooling machine 220 and immediately upstream of the laser assembly 212.

The laser assembly 212, on the other hand, is situated and equipped immediately downstream of the material take-off machine 90 and immediately upstream of the battery paste application machine 222. Relative to the laser assembly 112, the laser assembly 212 can be considered a second laser assembly 212 in the larger battery grid and plate manufacture assembly production line. Here, the second laser assembly 212 is situated and equipped downstream of the first laser assembly 112 and, concomitantly, laser beam emittance via the second laser assembly 212 occurs downstream of laser beam emittance via the first laser assembly 112. The laser assembly 212 includes, as its primary components, a generator and control assembly 284 and a laser head 286. The laser head 286 is mounted in place directly above the unspooled continuous strip of metal battery grids as the grids exit the material take-off machine 90 and as the grids are being transported to the battery paste application machine 222. Laser beams from the laser head 86 can hence be directed generally downward at the continuous strip of metal battery grids. Movement of the continuous strip of metal battery grids need not cease or otherwise pause for application of the associated laser beam(s). Contaminant formations like corrosion, oxide, and scale are targeted for removal via the laser assembly 212. After application of the laser beam(s), electrochemically-active battery paste material is applied to the continuous strip of metal battery grids via the battery paste application machine 222. The battery paste application machine 222 is a steel belt paster machine, in this example, but could take other forms in other embodiments.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

1. A method of making metal battery grids for lead-acid battery manufacture, the method comprising:
continuously producing a continuous strip of metal battery grids; and
emitting a laser beam to at least one exterior surface of the continuous strip of metal battery grids downstream of continuously producing the continuous strip of metal battery grids.

2. The method of making metal battery grids for lead-acid battery manufacture as set forth in claim 1, wherein continuously producing the continuous strip of metal battery grids involves continuously casting the continuous strip of metal battery grids, or involves continuously punching the continuous strip of metal battery grids.

3. The method of making metal battery grids for lead-acid battery manufacture as set forth in claim 1, wherein the at least one exterior surface comprises an upper exterior surface of the continuous strip of metal battery grids, a lower exterior surface of the continuous strip of metal battery grids, or both the upper and lower exterior surfaces of the continuous strip of metal battery grids, and wherein emitting the laser beam to at least one exterior surface of the continuous strip of metal battery grids involves emitting the laser beam to the upper exterior surface, to the lower exterior surface, or to both the upper and lower exterior surfaces.

4. The method of making metal battery grids for lead-acid battery manufacture as set forth in claim 1, wherein emitting the laser beam to at least one exterior surface of the continuous strip of metal battery grids involves emitting the laser beam upstream of application of an electrochemically-active battery paste material to the continuous strip of metal battery grids for removal of residual surface lubricant or oil or both from the continuous web of metal battery grids as a consequence of the continuous production of the continuous strip of metal battery grids.

5. The method of making metal battery grids for lead-acid battery manufacture as set forth in claim 1, wherein emitting the laser beam to at least one exterior surface of the continuous strip of metal battery grids involves emitting the laser beam upstream of a spooling operation of the continuous strip of metal battery grids for removal of residual surface lubricant or oil or both from the continuous web of metal battery grids as a consequence of the continuous production of the continuous strip of metal battery grids.

6. The method of making metal battery grids for lead-acid battery manufacture as set forth in claim 1, wherein emitting the laser beam to at least one exterior surface of the continuous strip of metal battery grids involves emitting the laser beam upstream of application of an electrochemically-active battery paste material to the continuous strip of metal battery grids for removal of surface corrosion from the continuous web of metal battery grids.

7. The method of making metal battery grids for lead-acid battery manufacture as set forth in claim 1, wherein emitting the laser beam to at least one exterior surface of the continuous strip of metal battery grids involves emitting the laser beam downstream of an unspooling operation of the continuous strip of metal battery grids and upstream of application of an electrochemically-active battery paste material to the continuous strip of metal battery grids for removal of surface corrosion from the continuous web of metal battery grids.

8. The method of making metal battery grids for lead-acid battery manufacture as set forth in claim 1, wherein emitting the laser beam to at least one exterior surface of the continuous strip of metal battery grids involves emitting a first laser beam upstream of a spooling operation of the continuous strip of metal battery grids and involves emitting a second laser beam upstream of application of an electrochemically-active battery paste material to the continuous strip of metal battery grids.

9. The method of making metal battery grids for lead-acid battery manufacture as set forth in claim 1, wherein emitting the laser beam to at least one exterior surface of the continuous strip of metal battery grids involves emitting the laser beam while the continuous strip of metal battery grids is in the midst of moving downstream of continuously producing the continuous strip of metal battery grids and without cessation of movement of the continuous strip of metal battery grids.

10. A metal battery grid manufacture assembly for lead-acid batteries, the metal battery grid manufacture assembly comprising:
a continuous production machine for producing a continuous strip of metal battery grids; and
at least one laser assembly situated downstream of the continuous production machine for emitting a laser beam to at least one exterior surface of the continuous strip of metal battery grids for cleaning the at least one exterior surface of the continuous strip of metal battery grids.

11. The metal battery grid manufacture assembly as set forth in claim 10, wherein the continuous production machine is a continuous casting machine or is a continuous punching machine.

12. The metal battery grid manufacture assembly as set forth in claim 10, wherein the at least one laser assembly is at least one fiber laser assembly.

13. The metal battery grid manufacture assembly as set forth in claim 10, wherein the at least one exterior surface comprises an upper exterior surface of the continuous strip of metal battery grids, a lower exterior surface of the continuous strip of metal battery grids, or both the upper and lower exterior surfaces of the continuous strip of metal battery grids, and wherein the at least one laser assembly is configured to emit the laser beam to the upper exterior surface, to the lower exterior surface, or to both the upper and lower exterior surfaces.

14. The metal battery grid manufacture assembly as set forth in claim 10, wherein the at least one laser assembly is configured to emit the laser beam to the at least one exterior surface of the continuous strip of metal battery grids while the continuous strip of metal battery grids is in the midst of moving downstream of the continuous production machine.

15. The metal battery grid manufacture assembly as set forth in claim 10, wherein the continuous strip of metal battery grids has residual lubricant or oil or both residing on the at least one exterior surface, has corrosion residing on the at least one exterior surface, or has both residual lubricant or oil or both and corrosion residing on the at least one exterior surface, and wherein cleaning the at least one exterior surface of the continuous strip of metal battery grids removes the residual lubricant or oil or both and/or the corrosion from the at least one exterior surface.

16. The metal battery grid manufacture assembly as set forth in claim 10, wherein the at least one laser assembly comprises a first laser assembly situated downstream of the continuous production machine and upstream of a spooling machine, and a second laser assembly situated downstream of the continuous production machine and downstream of an unspooling machine.

17. A battery plate manufacture assembly production line comprising the metal battery grid manufacture assembly of claim 10, and further comprising an electrochemically active battery paste application machine, wherein the battery plate manufacture assembly production line lacks an ultrasonic cleaning operation.

18. A method of making metal battery grids for lead-acid battery manufacture, the method comprising:
continuously producing a continuous strip of metal battery grids;
emitting a first laser beam to at least one exterior surface of the continuous strip of metal battery grids downstream of continuously producing the continuous strip of metal battery grids and upstream of a spooling operation of the continuous strip of metal battery grids; and
emitting a second laser beam to the at least one exterior surface of the continuous strip of metal battery grids downstream of emitting the first laser beam and upstream of application of an electrochemically-active battery paste material to the continuous strip of metal battery grids.

19. The method of making metal battery grids for lead-acid battery manufacture as set forth in claim 18, wherein:
emitting the first laser beam to the at least one exterior surface of the continuous strip of metal battery grids involves emitting the first laser beam while the continuous strip of metal battery grids is in the midst of moving downstream of continuously producing the continuous strip of metal battery grids and upstream of the spooling operation of the continuous strip of metal battery grids; and
emitting the second laser beam to the at least one exterior surface of the continuous strip of metal battery grids involves emitting the second laser beam while the continuous strip of metal battery grids is in the midst of moving downstream of continuously producing the continuous strip of metal battery grids and upstream of application of the electrochemically-active battery paste material to the continuous strip of metal battery grids.

20. The method of making metal battery grids for lead-acid battery manufacture as set forth in claim 19, wherein the method of making metal battery grids for lead-acid battery manufacture is carried out in the absence of ultrasonic cleaning to the continuous strip of metal battery grids.
